(19) United States
(12) Patent Application Publication
(10) Pub. No.: US 2009/0264026 A1
(43) Pub. Date: Oct. 22, 2009

(54) LOW-VOLTAGE ELECTRICAL DEVICE COMPRISING A SPRING TERMINAL

(75) Inventor: Ariel RUIZ, VILLEURBANNE (FR)

Correspondence Address: CANTOR COLBURN, LLP, 20 Church Street, 22nd Floor, Hartford, CT, 06103, US

(73) Assignee: ABB FRANCE, RUEIL-MALMAISON (FR)

(21) Appl. No.: 12/427,852

(22) Filed: Apr. 22, 2009

(30) Foreign Application Priority Data
Apr. 22, 2008 (FR) 08/02245

(51) Int. Cl. H01R 13/40

(52) U.S. Cl. 439/733.1

(57) ABSTRACT

Low-voltage electrical device comprising a spring terminal The invention relates to a low-voltage electrical device comprising an insulating body and at least one spring terminal housed in the insulating body, the insulating body having a first opening for the insertion of a conductor intended to be connected in the terminal and a second opening for the insertion of a tool intended to collaborate with the spring of the terminal to allow the conductor to be inserted into and/or removed from the terminal. The device comprises a hatch that can move between a first, rest, position in which the hatch at least partially closes off the opening for the insertion of a tool, and a second position that allows the tool to pass, the hatch comprising a portion that is inclined with respect to the direction of insertion of the tool the gradient of which is directed in the direction of travel from the second position toward the first, rest, position of the hatch, and the insulating body comprising an inclined portion situated facing the inclined portion of the hatch, the gradient of which is directed in the opposite direction to that of the inclined portion of the hatch.

### FIELD OF THE INVENTION

The present invention relates to a low-voltage electrical device comprising at least one spring terminal.

### BACKGROUND OF THE INVENTION

It is known practice to produce a low-voltage electrical device comprising an insulating body and at least one spring terminal housed in the insulating body, the insulating body having a first opening for the insertion of a conductor intended to be connected in the terminal and a second opening for the insertion of a tool intended to collaborate with the spring of the terminal to allow the conductor to be inserted into and/or removed from the terminal.

A device of this type is satisfactory in that it allows the conductor to be introduced into and removed from the terminal, the spring terminals in addition affording effective clamping over time.

However, the users of this type of terminal do sometimes make mistakes in the way they use these terminals.

In particular, it is possible for a conductor to be inserted into the opening intended for the tool, or for a tool to be inserted into the opening intended for the conductor.

This may result either in poor connection of the conductor or in damage to the terminal spring.

Further, in order to use these terminals, it is necessary to introduce the tip of the tool at an orientation that will allow the entire tip edge to press against the clamping branch of the spring and to avoid inserting this tool in such a way that its tip runs transversely to the plane of the clamping branch, in order to avoid wedging the tool on one side of the spring.

### BRIEF SUMMARY OF THE INVENTION

The present invention solves all or some of the abovementioned disadvantages.

To this end, the subject of the present invention is a device of the aforementioned type, wherein the device comprises a hatch that can move between a first, rest, position in which the hatch at least partially closes off the opening for the insertion of a tool, and a second position that allows the tool to pass, the hatch comprising a portion that is inclined with respect to the direction of insertion of the tool the gradient of which is directed in the direction of travel from the second position toward the first, rest, position of the hatch, and the insulating body comprising an inclined portion situated facing the inclined portion of the hatch, the gradient of which is directed in the opposite direction to that of the inclined portion of the hatch.

By virtue of the provisions according to the invention, a user can observe visually that the opening closed off by the hatch is the opening into which to insert the tool, and that the opening into which to insert the conductor is the open opening. In addition, that makes it easier to guide the tip of the screwdriver in a groove thus defined by the inclined portion of the wall of the housing and the inclined portion of the hatch.

The hatch retracts as the user inserts the tool into the appropriate opening.

Advantageously, the hatch is capable of translational movement.

These arrangements allow this hatch to be produced in a simple way that occupies little space.

Advantageously, the inclined portion is formed on the front edge of the hatch, in the direction of travel from the second position toward the first, rest, position of the hatch.

According to one embodiment, the hatch comprises a flat portion substantially perpendicular to the direction of insertion of a tool into the second opening of the insulating body, situated to the rear of the inclined portion in the direction of travel from the second position toward the first, rest, position of the hatch.

Advantageously, the inclined portion covers at least half the cross sectional area of the opening for the insertion of a tool.

These arrangements make it possible to guarantee that the end edge of the screwdriver is directed transversely to the direction of travel of the hatch as it is inserted, this being desirable so that this end edge is positioned in an orientation that will allow it to press substantially linearly on the bearing branch of the spring.

These provisions also make it possible to avoid a conductor being inserted into the opening for the insertion of the tool.

Advantageously, the hatch and the return means are produced as a single piece.

According to one embodiment, the device comprises at least two spring terminals, the two hatches intended to close off the two openings for the insertion of a tool and the return means for the two terminals being produced as a single piece.

According to one embodiment, the return means comprise a serpentine spring.

### BRIEF DESCRIPTION OF THE DRAWINGS

The invention will be better understood from the detailed description set out hereinbelow with reference to the attached drawing in which:

FIG. 1 is a schematic partial sectional view of an electrical device according to the invention in the region of a connection terminal;

FIGS. 2 to 6 are views of details of FIG. 1 illustrating how the hatch with which the device according to the invention is equipped operates;

FIG. 7 is a view from above of a second embodiment of a hatch for a device according to the invention.

### DETAILED DESCRIPTION OF THE PREFERRED EMBODIMENTS

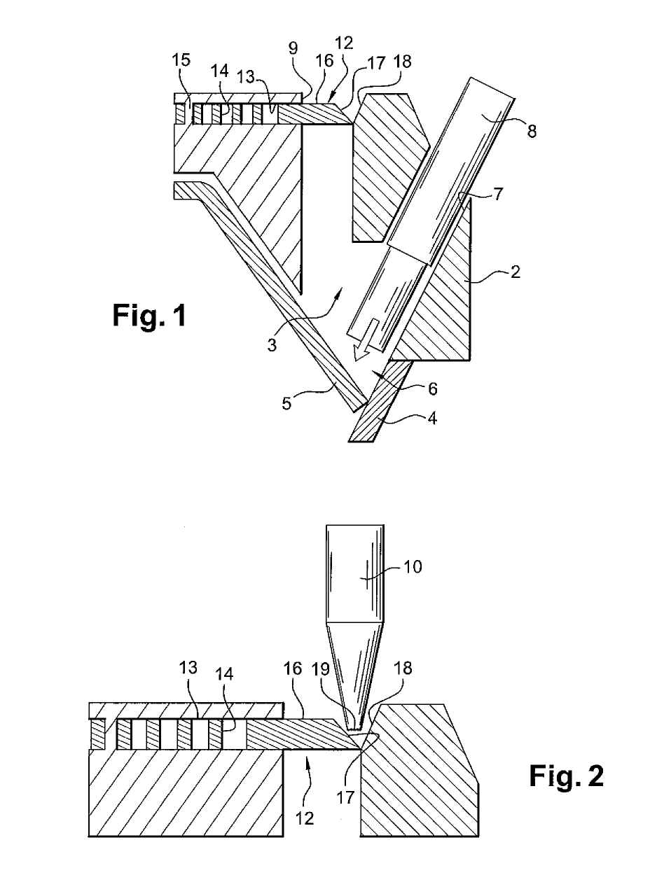

According to a first embodiment depicted in FIGS. 1 to 6, a low-voltage electrical device according to the invention comprises an insulating body 2 and a spring terminal housed in a housing 3 of the insulating body.

The terminal comprises a conducting connecting strip 4 and a clamping spring comprising a clamping branch 5.

A clamping space 6 is defined between the clamping branch 5 of the spring and a portion of the strip 4.

The insulating body 2 comprises a first opening 7 for the insertion of a conductor 8 intended to be connected in the terminal, in the form of a passage connecting the housing 3 of the terminal to the outside of the device through the insulating body. This passage opens into the housing 3 of the terminal opposite the clamping space 6 defined by the terminal.

The insulating body 2 comprises a second opening 9 for the insertion of a tool 10 of the screwdriver type, in the form of a passage connecting the housing 3 of the terminal to the outside of the device through the insulating body. This passage opens into the housing 3 of the terminal opposite the clamping branch 5 of the spring. It is thus possible for this branch to be pushed aside using the tool 10 to gain access to the clamping space 6 and allow a conductor 8 to be inserted or removed.

According to one feature of the invention, the device additionally comprises a hatch 12 intended at least partially to close the opening 9 for the insertion of a tool 10.

The hatch 12 is housed in a housing 13 of the insulating body formed transversely to the passage for the insertion of the tool that forms the opening 9.

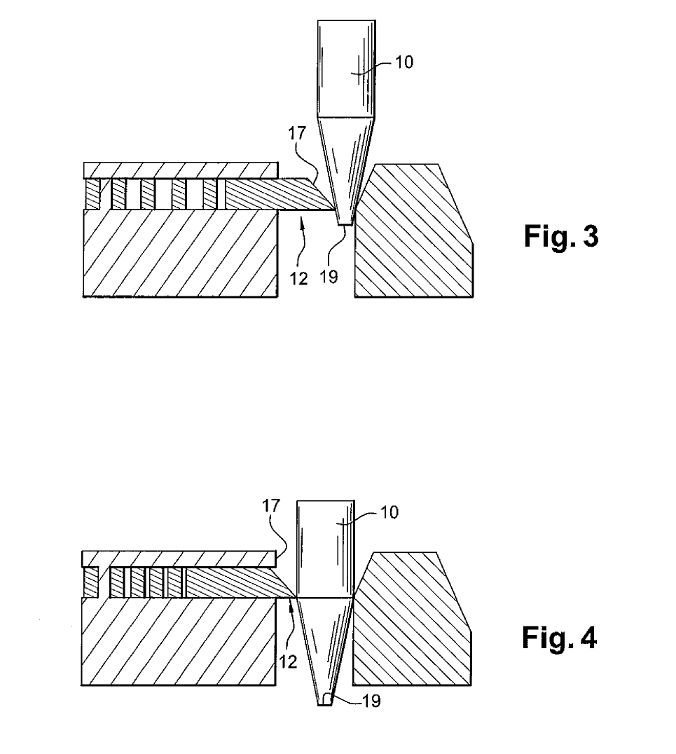

The hatch 12 can be moved translationally in the housing 13 between a first, rest, position visible in FIGS. 1 and 2 in which the hatch 12 closes off the opening 9 for the insertion of a tool 10, and a second position that allows the tool 10 to pass, as depicted in FIG. 4.

The hatch 12 is subjected to the action of a spring 14 that constitutes a means of returning it to the rest position. The spring is formed as a single piece with the hatch and is serpentine shaped. The spring 14 bears against a lug 15 formed in the housing and around which one of the corrugations of the spring is wound.

The hatch 12 comprises a flat portion 16, directed substantially perpendicular to the axis A of the tool insertion passage and a portion 17 that is inclined with respect to the flat portion 16 on the front edge of the hatch.

The inclined portion 17 of the hatch 12 covers less than half of the cross-sectional area of the insertion opening 9.

The wall of the insulating casing comprises, opposite the front edge of the hatch, an inclined portion 18 of a gradient directed in the opposite direction to the gradient of the inclined portion 17 of the hatch.

The inclined portion 17 of the hatch is intended to collaborate with the tapering part 19 of a tool 10, particularly a part consisting of an edge 19 of elongate shape directed substantially transversely to the direction of travel of the hatch.

As illustrated in FIGS. 2 to 4, as the edge 19 presses slidingly against the surface of the inclined portion, the movement with which the tool 10 is inserted is converted into a translational movement of the hatch 12 toward the inside of the housing 13 against the action of the return means 14.

The hatch thus retracts as illustrated in FIGS. 3 and 4.

It should be noted that the pressure of an element against the flat portion 16 of the hatch 12 does not cause the hatch to retract because this pressure is in one plane and does not allow relative sliding of the element and of the hatch.

Thus if the edge 19 is directed parallel to the direction of movement of the hatch, the edge will press against the flat portion of the hatch, as depicted in FIG. 5, and the hatch will not retract to allow the screwdriver to pass.

Likewise, if a user attempts to insert a conductor into the tool insertion opening, the end 20 of the conductor 8, which is of a diameter greater than the dimensions of the inclined portion 17 of the hatch, will press against the flat portion 16 of the hatch and not allow the hatch to retract and the conductor 8 to pass, as depicted in FIG. 6.

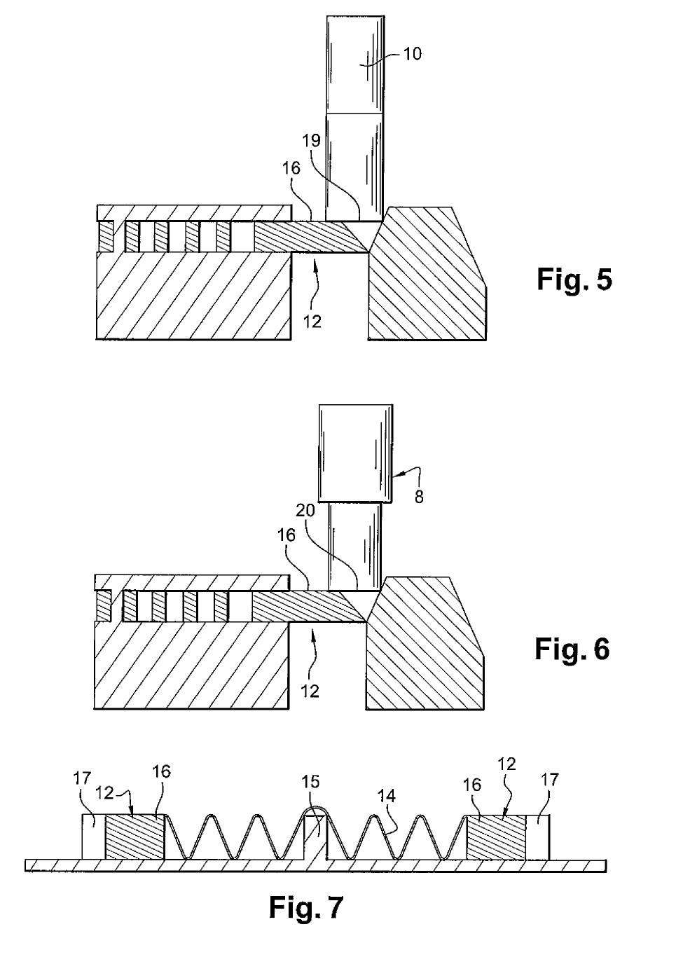

According to a second embodiment depicted in FIG. 7, the device comprises two spring terminals which have not been depicted.

The two hatches 12 intended to close off the two tool insertion openings and the return means 14 for the two terminals are produced as a single piece.

The hatches 12 are located one on each side of a central spring 14.

This element is housed in a housing 13 that has two openings, not depicted, opening into the tool insertion passages for the two terminals.

The spring 14 presses against a lug 15 created in the housing 13 and around which one of the corrugations of the spring is wound in order to provide a return force to the two hatches 12, in two opposite directions.

According to an undepicted alternative form of the first embodiment, the hatch does not fully close off the tool insertion opening in the rest position so as to leave an open portion between the front edge of the hatch and the wall of the casing. Advantageously, the open portion allows the edge of a tool to pass in a determined orientation. Once the edge of the tool has been inserted into the open portion, the hatch can be pushed back into its housing by pressure on its front edge. In this alternative form, there is no need to create an inclined portion at the front of the hatch.

Although the invention has been described in conjunction with particular embodiments, it is quite obvious that it is not in any way restricted thereto and that it encompasses all technical equivalents of the means described and combinations thereof where these fall within the scope of the invention.

1. A low-voltage electrical device comprising an insulating body and at least one spring terminal housed in the insulating body, the insulating body having a first opening for insertion of a conductor intended to be connected in the terminal and a second opening for insertion of a tool intended to collaborate with the spring of the terminal to allow the conductor to be inserted into and/or removed from the terminal,
wherein
the device comprises a hatch that can move between a first, rest, position in which the hatch at least partially closes off the opening for the insertion of a tool, and a second position that allows the tool to pass, the hatch comprising a portion that is inclined with respect to a direction of insertion of the tool a gradient of which is directed in a direction of travel from the second position toward the first, rest, position of the hatch, and the insulating body comprising an inclined portion situated facing the inclined portion of the hatch, a gradient of which is directed in a opposite direction to that of the inclined portion of the hatch.

2. The electrical device as claimed in claim 1, the hatch is capable of translational movement.

3. The device as claimed in claim 1, the inclined portion is formed on a front edge of the hatch, in the direction of travel from the second position toward the first, rest, position of the hatch.

4. The device as claimed in claim 3, wherein the hatch comprises a flat portion substantially perpendicular to the direction of insertion of a tool into the second opening of the insulating body, situated to a rear of the inclined portion in the direction of travel from the second position toward the first, rest, position of the hatch.

5. The device as claimed in claim 1, the inclined portion covers at least half a cross sectional area of the opening for the insertion of a tool.

6. The device as claimed in claim 1, wherein the hatch and return means are produced as a single piece.

7. The device as claimed in claim 6 least two spring terminals, wherein two hatches intended to close off two openings for the insertion of a tool and return means for the two terminals being produced as a single piece.

8. The device as claimed in claim 1, wherein return means comprise a serpentine spring.
